(19) United States
(12) Patent Application Publication
(10) Pub. No.: US 2026/0204660 A1
(43) Pub. Date: Jul. 16, 2026

(54) SOLID-STATE SECONDARY BATTERY

(71) Applicant: HONDA MOTOR CO., LTD., Tokyo (JP)

(72) Inventors: Takashi NAKAGAWA, Saitama (JP); Kyohei IZUMI, Saitama (JP); Shuntaroh UJIIE, Saitama (JP)

(21) Appl. No.: 19/444,197

(22) Filed: Jan. 9, 2026

(30) Foreign Application Priority Data
Jan. 14, 2025 (JP) 2025-004721

(51) Int. Cl. H01M 10/42; H01M 4/02; H01M 10/0585

(52) U.S. Cl. CPC H01M 10/4235; H01M 10/0585; H01M 2004/027

(57) ABSTRACT

A solid-state secondary battery according to one embodiment of the present invention has an electrode laminate in which a positive electrode layer, a negative electrode layer, a solid electrolyte layer provided between the positive electrode layer and the negative electrode layer, and an intermediate layer provided between the negative electrode layer and the solid electrolyte layer are laminated, the negative electrode layer includes a negative electrode current collector, the negative electrode current collector has an arithmetic average roughness Ra of smaller than 2.5 μm, and the intermediate layer has a smaller composite elastic modulus than the negative electrode current collector.

This application is based on and claims the benefit of priority from Japanese Patent Application No. 2025-004721, filed on 14 Jan. 2025, the content of which is incorporated herein by reference.

### BACKGROUND OF THE INVENTION

### Field of the Invention

The present invention relates to a solid-state secondary battery.

### Related Art

Recently, research and development regarding secondary batteries that contribute to energy efficiency has been underway to enable more people to secure access to affordable, reliable, sustainable, and advanced energy.

As such secondary batteries, solid-state secondary batteries having a solid electrolyte layer disposed between a positive electrode layer and a negative electrode layer are known. As the solid-state secondary batteries, a secondary battery in which a positive electrode having a positive electrode active material layer containing a positive electrode active material capable of absorbing and releasing lithium ions and a negative electrode in which lithium metal is precipitated on a negative electrode current collector during charging and a lithium metal layer is generated are combined together is known (for example, Patent Document 1). Patent Document 1 discloses, as the negative electrode current collector, a negative electrode current collector having a ten-point average roughness (Rz_{JIS}) of 3 to 50 μm on a surface on a solid electrolyte layer side.
Patent Document 1: Japanese Unexamined Patent Application, Publication No. 2022-114216

### SUMMARY OF THE INVENTION

Meanwhile, one issue in solid-state secondary battery-related technology is improvement in cycle characteristics. According to studies by the present inventors, it has been clarified that in a solid-state secondary battery configured to generate a lithium metal layer on a negative electrode current collector during charging, due to a short circuit by current concentration, uneven lithium precipitation, and formation of local pores, DC resistance in a charged state rises, and deterioration of the cycle characteristics is caused.

The present invention has been made in consideration of the above-described circumstance, and an object of the present invention is to provide a solid-state secondary battery having low DC resistance in a charged state and improved cycle characteristics. In addition, the solid-state secondary battery further contributes to energy efficiency.

The present inventors have found that it is effective for the above-described object to use a negative electrode current collector having a flat surface as a negative electrode current collector and to provide an intermediate layer having a smaller composite elastic modulus and more easily deforming than the negative electrode current collector between a solid electrolyte layer and the negative electrode current collector and completed the present invention. Therefore, the present invention provides the following.

(1) A solid-state secondary battery having an electrode laminate in which a positive electrode layer, a negative electrode layer, a solid electrolyte layer provided between the positive electrode layer and the negative electrode layer, and an intermediate layer provided between the negative electrode layer and the solid electrolyte layer are laminated, wherein the negative electrode layer includes a negative electrode current collector, the negative electrode current collector has an arithmetic average roughness Ra of smaller than 2.5 μm, and the intermediate layer has a smaller composite elastic modulus than the negative electrode current collector.

According to the solid-state secondary battery of (1), since a surface of the negative electrode current collector has an arithmetic average roughness Ra of smaller than 2.5 μm and is flat, a short circuit by current concentration or uneven lithium precipitation is unlikely to occur during charging, and local pores are unlikely to be formed in a lithium metal layer. In addition, since the intermediate layer has a smaller composite elastic modulus than the negative electrode current collector, and the negative electrode current collector and the intermediate layer are likely to adhere to each other due to deformation of the intermediate layer, lithium easily migrates to the negative electrode current collector during charging. Therefore, the solid-state secondary battery of (1) has low DC resistance in a charged state, and the cycle characteristics improve.

(2) The solid-state secondary battery according to (1), wherein the negative electrode current collector has a maximum height roughness Rz of smaller than 10 μm.

According to the solid-state secondary battery of (2), since the maximum height roughness Rz of the surface of the negative electrode current collector is smaller than 10 μm, and unevenness on the surface is fine, a short circuit by current concentration or uneven lithium precipitation is more unlikely to occur during charging, and local pores are more unlikely to be formed in the lithium metal layer.

(3) The solid-state secondary battery according to (1) or (2), wherein before charging, the negative electrode current collector is in contact with the intermediate layer.

According to the solid-state secondary battery of (3), since the negative electrode current collector is in contact with the intermediate layer, it becomes easier for lithium to migrate to the negative electrode current collector during charging.

(4) The solid-state secondary battery according to any one of (1) to (3), wherein the intermediate layer has an arithmetic average roughness Ra of smaller than 1 μm and a maximum height roughness Rz of smaller than 4 μm on a side opposite to the negative electrode current collector.

According to the solid-state secondary battery of (4), since a surface of the intermediate layer on the side opposite to the negative electrode current collector has an arithmetic average roughness Ra of smaller than 1 μm, is flat, and has a maximum height roughness Rz of smaller than 4 μm, and the unevenness on the surface is fine, a short circuit by current concentration or uneven lithium precipitation is far more unlikely to occur during charging, and local pores are far more unlikely to be formed in the lithium metal layer.

(5) The solid-state secondary battery according to any one of (1) to (4), wherein the intermediate layer has a composite elastic modulus of less than 1 GPa.

According to the solid-state secondary battery of (5), since the composite elastic modulus of the intermediate layer is the above-described value, even in a case where a thickness of the negative electrode layer has changed due to charging and discharging, it is possible to increase contact areas between the solid electrolyte layer and the intermediate layer and between the negative electrode layer and the intermediate layer. Therefore, it is possible to decrease the DC resistance during charging and discharging at a large current density.

(6) The solid-state secondary battery according to any one of (1) to (5), wherein the intermediate layer has a relative density of 30% to 60%.

According to the solid-state secondary battery of (6), since the relative density of the intermediate layer is within the above-described range, it is possible to maintain adhesion between the solid electrolyte layer and the intermediate layer and between the negative electrode layer and the intermediate layer. Therefore, it is possible to improve the cycle characteristics of the solid-state secondary battery.

(7) The solid-state secondary battery according to any one of (1) to (6), wherein the intermediate layer contains amorphous carbon.

According to the solid-state secondary battery of (7), it is possible to curb formation of dendrite due to precipitation of a charge transfer medium in the intermediate layer. Therefore, it is possible to further improve the cycle characteristics of the solid-state secondary battery.

(8) The solid-state secondary battery according to any one of (1) to (7), wherein the intermediate layer has a smaller composite elastic modulus than the solid electrolyte layer.

According to the solid-state secondary battery of (8), since the intermediate layer has a smaller composite elastic modulus than the solid electrolyte layer, the solid electrolyte layer and the intermediate layer are likely to adhere to each other due to deformation of the intermediate layer, and lithium easily migrates to the intermediate layer during charging.

According to the present invention, it becomes possible to provide a solid-state secondary battery having low DC resistance in a charged state and improved cycle characteristics.

### BRIEF DESCRIPTION OF THE DRAWINGS

FIG. 1 is a cross-sectional view of a solid-state secondary battery according to one embodiment of the present invention;

FIG. 2 is a cross-sectional view showing a charged state of the solid-state secondary battery shown in FIG. 1;

FIG. 3 is a SEM photograph of a cross section of an electrode laminate in a SOC 50% state taken out from a solid-state secondary battery obtained in Example 2;

FIG. 4A is a SEM photograph of a cross section of an electrode laminate in a SOC 50% state taken out from a solid-state secondary battery obtained in Comparative Example 1; and

FIG. 4B is an enlarged SEM photograph of FIG. 4A.

### DETAILED DESCRIPTION OF THE INVENTION

Hereinafter, an embodiment of the present invention will be described with reference to drawings. In the present embodiment, a solid-state secondary battery is a lithium metal battery in which lithium ions are used as a charge transfer medium.

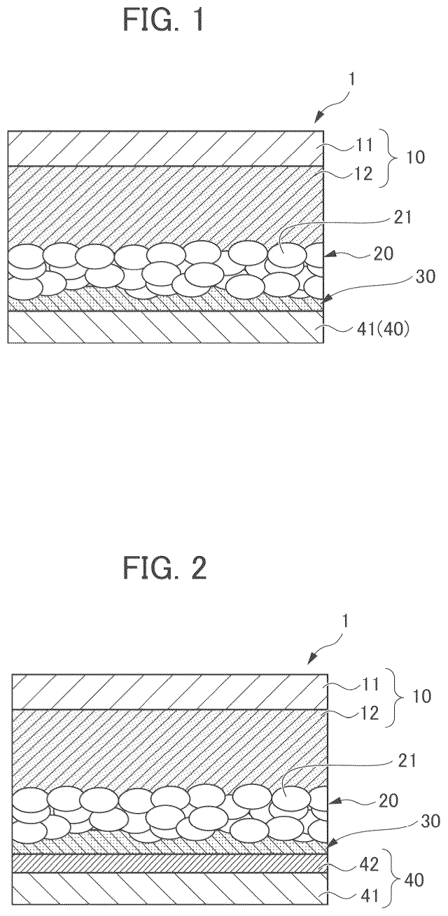

FIG. 1 is a cross-sectional view of one example showing a solid-state secondary battery according to a first embodiment of the present invention. FIG. 2 is a cross-sectional view of one example showing a charged state of the solid-state secondary battery shown in FIG. 1.

A solid-state secondary battery 1 of the present embodiment has an electrode laminate in which a positive electrode layer 10, a solid electrolyte layer 20, an intermediate layer 30, and a negative electrode layer 40 are laminated in this order. The positive electrode layer 10, the solid electrolyte layer 20, the intermediate layer 30, and the negative electrode layer 40 each need to be in contact with each other to enable lithium ions or lithium metal to migrate, and each layer may be joined to each other. In order to make lithium ions or lithium metal easily migrate between individual layers, the solid-state secondary battery 1 may be restrained in a lamination direction with a subsequent member (not shown). In the following description, the composite elastic moduli of the solid electrolyte layer 20, the intermediate layer 30, and the negative electrode layer 40 (negative electrode current collector 41) mean values after assembly of the electrode laminate unless particularly otherwise described. The arithmetic average roughness Ra and maximum height roughness Rz of the intermediate layer 30 mean values after the assembly of the electrode laminate unless particularly otherwise described. The arithmetic average roughness Ra and maximum height roughness Rz of the negative electrode layer 40 (negative electrode current collector 41) mean values after the assembly of the electrode laminate unless particularly otherwise described. After the assembly of the electrode laminate refers to a state of the electrode laminate immediately after being assembled by laminating the individual layers of the solid-state secondary battery 1. The arithmetic average roughness Ra and maximum height roughness Rz of the negative electrode layer 40 (negative electrode current collector 41) shows the same values before and after the assembly of the electrode laminate depending on material characteristics thereof or assembly conditions of the electrode laminate.

The positive electrode layer 10 has a positive electrode current collector 11 and a positive electrode active material layer 12 disposed on a surface of the positive electrode current collector.

Examples of the shape of the positive electrode current collector 11 include a foil shape, a plate shape, a mesh shape, a non-woven fabric shape, a foamy shape, and the like. Examples of a material of the positive electrode current collector 11 include aluminum, an aluminum alloy, stainless steel, nickel, iron, and titanium.

The positive electrode active material layer 12 contains a positive electrode active material. The positive electrode active material is a lithium compound that releases lithium ions during charging and absorbs lithium ions during discharging. As the lithium compound, it is possible to use, for example, a layered active material, a spinel-type active material, and an olivine-type active material. Specific examples of the positive electrode active material include lithium cobalt oxide (LiCoO₂), lithium nickel oxide (LiNiO₂), lithium nickel manganese cobalt oxide (NMC: LiNiₚMn_{g}CoᵣO₂ (p+q+r=1)), LiNiₚAl_{q}CoᵣO₂ (p+q+r=1), lithium manganese oxide (LiMn₂O₄), heteroelement-substituted Li—Mn spinel represented by Li₁₊ₓMn₂₋ₓ₋M_{y}O₄ (x+y=2, M is at least one selected from Al, Mg, Co, Fe, Ni, and Zn), lithium titanate (oxide containing Li and Ti), lithium metal phosphate (LiMPO₄, M is at least one selected from Fe, Mn, Co, and Ni), and the like. The positive electrode active material layer 12 may further contain a conductive auxiliary agent or a binder.

The solid electrolyte layer 20 contains a solid electrolyte material 21. As examples of the solid electrolyte material 21, it is possible to use a sulfide solid electrolyte, an oxide solid electrolyte, a nitride solid electrolyte, and a halide solid electrolyte. Examples of the sulfide solid electrolyte include Li₂S—P₂S₅, Li₂S—P₂S₅—LiI, and the like. The sulfide solid electrolyte may have an argyrodite-type crystal structure. Examples of the oxide solid electrolyte include NASICON-type oxides, garnet-type oxides, and perovskite-type oxides. Examples of the NASICON-type oxides include oxides containing Li, Al, Ti, P, and O (for example, Li_{1.5}Al_{0.5}Ti_{1.5}(PO₄)₃). Examples of the garnet-type oxides include oxides containing Li, La, Zr, and O (for example, Li₇La₃Zr₂O₂₂). Examples of the perovskite-type oxides include oxides containing Li, La, Ti, and O (for example, LiLaTiO₃). A thickness of the solid electrolyte layer 20 is, for example, within a range of 10 to 100 μm.

The solid electrolyte layer 20 may contain a binder. As the binder, it is possible to use, for example, a resin-based binder, a rubber-based binder, an elastomer-based binder, and a cellulose-based binder. Examples of a resin include polyvinylidene fluoride, polytetrafluoroethylene, polyimide, polyamide, and polyamideimide. Examples of the rubber-based binder include butadiene rubber, styrene butadiene rubber, nitrile-butadiene rubber, acrylic rubber, butyl rubber, and fluororubber. Examples of the elastomer-based binder include styrenic block copolymers such as a styrene-ethylene-butylene-styrene block copolymer and a styrene-isoprene-styrene block copolymer. Examples of the cellulose-based binder include carboxymethyl cellulose, methyl cellulose, and ethyl cellulose. A binder content of the solid electrolyte layer 20 may be, for example, within a range of 0.5 to 10 mass %.

A composite elastic modulus of the solid electrolyte layer 20 may be within a range of 10 to 100 GPa.

The intermediate layer 30 is disposed between the solid electrolyte layer 20 and the negative electrode layer 40. The intermediate layer 30 has pores through which the lithium metal, which is the charge transfer medium of the solid-state secondary battery 1, can pass. Due to the passing of the lithium metal through the intermediate layer 30, it is possible to uniformly precipitate the lithium metal on a surface of the negative electrode layer 40. A thickness of the intermediate layer 30 is, for example, within a range of 0.3 to 5 μm.

A composite elastic modulus of the intermediate layer 30 may be less than 1 GPa. The composite elastic modulus of the intermediate layer 30 may be within a range of 600 to 800 MPa. When the composite elastic modulus of the intermediate layer 30 is the above-described value, the intermediate layer 30 becomes highly flexible, and it is possible to increase contact areas between the solid electrolyte layer 20 and the intermediate layer 30 and between the negative electrode layer 40 and the intermediate layer 30 even in a case where a thickness of the negative electrode layer 40 has changed due to charging and discharging. Therefore, it is possible to decrease DC resistance at a large current density.

The composite elastic modulus of the intermediate layer 30 may be made to be smaller than the composite elastic moduli of the solid electrolyte layer 20 and the negative electrode current collector 41. The composite elastic modulus of the intermediate layer 30 may be smaller than the composite elastic modulus of the solid electrolyte layer 20 by a range of 0.1 to 10 GPa. The ratio of the composite elastic modulus of the intermediate layer 30 to the composite elastic modulus of the solid electrolyte layer 20 may be within a range of 1/1000 to 99/100. The composite elastic modulus of the intermediate layer 30 may be smaller than a composite elastic modulus of the negative electrode current collector 41 by a range of 0.1 to 10 GPa. The ratio of the composite elastic modulus of the intermediate layer 30 to the composite elastic modulus of the negative electrode current collector 41 may be within a range of 4/10000 to 6/10.

A relative density of the intermediate layer 30 may be within a range of 30% to 60%. The relative density means a percentage of a density of the molded intermediate layer relative to a true density. When the relative density of the intermediate layer 30 is the above-described value, it is possible to maintain adhesion between the solid electrolyte layer 20 and the intermediate layer 30 and between the negative electrode layer 40 and the intermediate layer 30 and to improve cycle characteristics of the solid-state secondary battery 1.

The intermediate layer 30 may contain a substance having a lithium metal conductivity and a substance having an electron conductivity. As the substance having a lithium metal conductivity, for example, amorphous carbon particles can be used. As the substance having an electron conductivity, for example, metal can be used. The metal may be particulate. Metal particles may be included in the intermediate layer 30 as a mixture with the amorphous carbon particles or may be included in the intermediate layer 30 in a state of being supported by the amorphous carbon particles. In addition, the metal may be present as a film on the surfaces of the amorphous carbon particles or may be contained in the amorphous carbon particles. When the intermediate layer 30 contains the amorphous carbon, it is possible to curb formation of dendrite due to precipitation of lithium in the intermediate layer 30. Therefore, the cycle characteristics of the solid-state secondary battery 1 further improve.

The amorphous carbon may be graphitizable carbon (soft carbon) or non-graphitizable carbon (hard carbon). Among carbon allotropes, the amorphous carbon needs to be carbon not exhibiting a clear crystalline state and may be an aggregate of fine graphite crystals. Specific examples of the amorphous carbon include carbon blacks such as acetylene black, furnace black, and Ketjen black, coke, activated carbon, CNT (carbon nanotubes), fullerene, and graphene.

As the metal that is contained in the intermediate layer 30, it is possible to use particles of a metal that forms an alloy with lithium. As an example of the metal, examples of the metal that forms an alloy with lithium include Mg, Zn, Al, In, Si, Ge, Sn, Ag, Au, Pt, Pd, Pb, Sb, and Bi.

The intermediate layer 30 may contain a binder aside from the above-described substances. As the binder, it is possible to use a binder that can be used as the binder in the solid electrolyte layer 20. Here, the binder that is used in the intermediate layer 30 and the binder that is used in the solid electrolyte layer 20 may be the same as or different from each other. A binder content of the intermediate layer 30 may be, for example, within a range of 0.5 to 10 mass %.

A surface of the intermediate layer 30 on a side opposite to the negative electrode current collector 41 may have an arithmetic average roughness Ra of smaller than 1 μm. In addition, the surface of the intermediate layer 30 on the side opposite to the negative electrode current collector 41 may have a maximum height roughness Rz of smaller than 4 μm. The surface of the intermediate layer 30 on the side opposite to the negative electrode current collector 41 may have an arithmetic average roughness Ra of smaller than 0.3 μm, and a maximum height roughness Rz of smaller than 1.5 μm.

The negative electrode layer 40 has the negative electrode current collector 41. The negative electrode current collector 41 has, for example, a foil shape or a plate shape. On a surface of the negative electrode current collector 41, lithium or an alloy containing lithium is precipitated. A material of the negative electrode current collector 41 may be a material that does not form an alloy with lithium or may be a material that forms an alloy with lithium. As the material that does not form an alloy with lithium, it is possible to use Cu, a Cu alloy, Ni, Fe, and stainless steel. As the material that forms an alloy with lithium, it is possible to use Mg, Zn, Al, In, Si, Ge, Sn, Ag, Au, Pt, Pd, Pb, Sb, and Bi. The negative electrode current collector 41 may be coated with a metal thin film or a carbon-coated thin film. The metal thin film may be a metal that forms an alloy with lithium.

The surface of the negative electrode current collector 41 has an arithmetic average roughness Ra of smaller than 2.5 μm and is made to be flat. The arithmetic average roughness Ra of the negative electrode current collector 41 may be smaller than 2.0 μm or may be smaller than 1.0 μm.

On the surface of the negative electrode current collector 41 on a side of the intermediate layer 30, a maximum height roughness Rz is smaller than 10 μm, and unevenness on the surface may be made to be fine. The maximum height roughness Rz of the negative electrode current collector 41 may be smaller than 8.0 μm or may be smaller than 5.0 μm. In the negative electrode current collector 41, the arithmetic average roughness Ra may be smaller than 2.5 μm, and the maximum height roughness Rz may be smaller than 10 μm, the arithmetic average roughness Ra may be smaller than 2.0 μm, and the maximum height roughness Rz may be smaller than 8.0 μm, or the arithmetic average roughness Ra may be smaller than 1.0 μm, and the maximum height roughness Rz may be smaller than 5.0 μm. The arithmetic average roughness Ra and maximum height roughness Rz of the negative electrode current collector 41 are, for example, values measured using a laser microscope. However, a measurement method is not limited to a method using the laser microscope, and the roughness can be measured using a contact-type, non-contact-type, or other surface roughness measurement method.

A composite elastic modulus of the negative electrode current collector 41 may be 1 to 220 GPa.

When the solid-state secondary battery 1 is charged, lithium ions are released from the positive electrode active material layer 12 of the positive electrode layer 10, and the lithium ions are precipitated on the surface of the negative electrode current collector 41 of the negative electrode layer 40. As a result, a lithium metal layer 42 is formed on the surface of the negative electrode current collector 41 as shown in FIG. 2. Due to formation of the lithium metal layer 42, a thickness of the charged solid-state secondary battery 1 becomes thicker than before charging. When the charged solid-state secondary battery 1 is discharged, lithium ions are released from the lithium metal layer 42, and the lithium ions are absorbed into the positive electrode active material layer 12. In the discharged solid-state secondary battery 1, the negative electrode current collector 41 adheres to the intermediate layer 30 as shown in FIG. 2.

A method for manufacturing the solid-state secondary battery 1 is not particularly limited. The solid-state secondary battery 1 can be manufactured by, for example, laminating the positive electrode layer 10, the solid electrolyte layer 20, the intermediate layer 30, and the negative electrode layer 40 in this order and pressurizing an obtained laminate. Due to the pressurizing, an electrode laminate in which the positive electrode layer 10, the solid electrolyte layer 20, the intermediate layer 30, and the negative electrode layer 40 are each joined to each other is formed.

According to the solid-state secondary battery 1 of the present embodiment configured as described above, since the surface of the negative electrode current collector 41 has an arithmetic average roughness Ra of smaller than 2.5 μm and is flat, a short circuit by current concentration or uneven lithium precipitation is unlikely to occur during charging, and local pores are unlikely to be formed in the lithium metal layer. In addition, since the composite elastic modulus of the intermediate layer 30 is smaller than that of the negative electrode current collector 41, and the negative electrode current collector 41 and the intermediate layer 30 are likely to adhere to each other due to deformation of the intermediate layer 30, lithium easily migrates to the negative electrode current collector during charging. Therefore, in the solid-state secondary battery 1, DC resistance in a charged state is low, and the cycle characteristics improve.

In the solid-state secondary battery 1 of the present embodiment, in a case where the maximum height roughness Rz of the negative electrode current collector 41 is smaller than 10 μm, since the unevenness on the surface of the negative electrode current collector 41 is fine, a short circuit by current concentration or uneven lithium precipitation is more unlikely to occur during charging, and local pores are more unlikely to be formed in the lithium metal layer.

In the solid-state secondary battery 1 of the present embodiment, in a case where the negative electrode current collector 41 before charging has adhered to the intermediate layer 30, lithium easily migrates to the negative electrode current collector 41 during charging.

In the solid-state secondary battery 1 of the present embodiment, in a case where the arithmetic average roughness Ra and maximum height roughness Rz of the surface of the intermediate layer 30 on the side opposite to the negative electrode current collector 41 are within the above-described ranges, since the surface of the intermediate layer 30 is flat, and the unevenness is fine, a short circuit by current concentration or uneven lithium precipitation is far more unlikely to occur during charging, and local pores are far more unlikely to be formed in the lithium metal layer.

In the solid-state secondary battery 1 of the present embodiment, in a case where the composite elastic modulus of the intermediate layer 30 is smaller than that of the solid electrolyte layer 20, since the solid electrolyte layer 20 and the intermediate layer 30 are likely to adhere to each other due to deformation of the intermediate layer 30, lithium easily migrates to the intermediate layer 30 during charging.

Hitherto, the embodiment of the present invention has been described, but the present invention is not limited to the above-described embodiment. For example, in the present embodiment, the solid-state secondary battery 1 is a lithium metal battery in which lithium ions are used as a charge transfer media, but the charge transfer media is not limited thereto. In the solid-state secondary battery 1 of the present embodiment, the thickness of the negative electrode layer may change due to charging and discharging.

### EXAMPLES

Hereinafter, the present invention will be further described with Examples, but the present invention is not limited to these Examples.

### Example 1

### (1) Production of Positive Electrode Layer

As a positive electrode current collector, a 15 μm-thick aluminum foil was provided. Lithium nickel manganese cobalt oxide (NCM622) as a positive electrode active material, an argyrodite-type sulfide solid electrolyte as a solid electrolyte material, carbon black as a conductive auxiliary agent, and an SBR (styrene butadiene rubber)-based binder as a binding agent were mixed together in proportions of 80 parts by mass, 17 parts by mass, 2 parts by mass, and 1 part by mass, respectively. 43 Parts by mass of butyl butyrate was dispersed in an obtained mixture to prepare a positive electrode active material layer slurry. The obtained positive electrode active material layer slurry was applied to both surfaces of a positive electrode current collector using a bar coater so that the basis weight after drying reached 27 mg/cm² and dried to form 80 μm-thick positive electrode active material layers, whereby a positive electrode layer was produced.

### (2) Production of Solid Electrolyte Layer Transfer Sheet

An argyrodite-type sulfide solid electrolyte (median diameter: 3.0 μm) and an SBR (styrene butadiene rubber)-based binder as a binder were mixed together in proportions of 97 parts by mass and 3 parts by mass. An obtained mixture was dispersed in a solvent to prepare a solid electrolyte slurry. The obtained solid electrolyte slurry was applied to a support sheet and dried to produce a solid electrolyte layer transfer sheet (the thickness of a solid electrolyte layer: 100 μm).

### (3) Production of Intermediate Layer Transfer Sheet

A total of 95 parts by mass of Sn particles (average particle diameter: 0.07 μm) as metal particles and acetylene black (average particle diameter: 0.05 μm) as amorphous carbon particles and 5 parts by mass of a PVDF-based binder as a binder were mixed together. An obtained mixture was dispersed in 1000 parts by mass of NMP (N-methyl-2-pyrrolidone) to prepare an intermediate layer slurry. The obtained intermediate layer slurry was applied to a support sheet and dried to produce an intermediate layer transfer sheet (the thickness of an intermediate layer: 3.0 μm).

### (4) Negative Electrode Layer

As a negative electrode current collector, an electrolytic nickel foil was provided. The thickness T, arithmetic average roughness Ra, and maximum height roughness Rz of the electrolytic nickel foil and the ratio Rz/T of the maximum height roughness Rz to the thickness T are shown in Table 1 below.

### (5) Production of Solid-State Secondary Battery

The solid electrolyte layer of the solid electrolyte layer transfer sheet was overlaid on a surface of a positive electrode active material layer of the positive electrode layer and joined thereto using a uniaxial pressing machine under joining conditions of a joining pressure of 90 MPa, a joining time of three minutes, and a joining temperature of room temperature. After that, the support sheet of the solid electrolyte layer transfer sheet was peeled off to obtain a positive electrode layer-solid electrolyte layer joined body. Next, the intermediate layer of the intermediate layer transfer sheet was overlaid on a surface of the solid electrolyte layer of a positive electrode layer-solid electrolyte layer laminate and joined thereto using the uniaxial pressing machine under joining conditions of a joining pressure of 290 MPa, a joining time of five minutes, and a joining temperature of room temperature. After that, the support sheet of the intermediate layer transfer sheet was peeled off to obtain a positive electrode layer-solid electrolyte layer-intermediate layer joined body. Next, a densification treatment was performed on an integrated body of the positive electrode layer-solid electrolyte layer-intermediate layer joined body using an isostatic pressing machine at a joining pressure of 980 MPa and a joining temperature of 120° C. for a joining time of five minutes. Next, the negative electrode current collector of a negative electrode layer was overlaid on a surface of the intermediate layer of the positive electrode layer-solid electrolyte layer-intermediate layer joined body to obtain an electrode laminate. The obtained electrode laminate was accommodated in an aluminum-laminated film exterior body to produce a solid-state secondary battery. A cushioning material was disposed on a negative electrode layer side and restrained at a restraining pressure of 3 MPa.

### Examples 2 to 5 and Comparative Example 1

Solid-state secondary batteries were produced in the same manner as in Example 1 except that an electrolytic copper foil (Example 2), an electrolytic nickel foil (Example 3), a silver-coated electrolytic copper foil (Example 4), a carbon-coated electrolytic copper foil (Example 5), and a nickel-plated electrolytic copper foil with roughened surface (Comparative Example 1) were used as the negative electrode current collector, respectively. The thickness T, arithmetic average roughness Ra, and maximum height roughness Rz of each negative electrode current collector and the ratio Rz/T of the maximum height roughness Rz to the thickness T are shown in Table 1 below.

### Comparative Example 2

A solid-state secondary battery was produced in the same manner as in Example 1 except that the electrode laminate was produced by overlaying the negative electrode current collector of the negative electrode layer on the surface of the solid electrolyte layer instead of joining the intermediate layer to the surface of a solid electrolyte layer of the positive electrode layer-solid electrolyte layer laminate.

TABLE 1

| | Negative electrode current collector | | | | | |
|---|---|---|---|---|---|---|
| | | | Arithmetic | Maximum | | Presence or |
| | | | average | height | | absence of |
| | | Thickness | roughness | roughness | | intermediate |
| | Material | T (μm) | Ra(μm) | Rz(μm) | Rz/T | layer |
| Example 1 | Ni | 10 | 0.11 | 0.6 | 0.06 | Present |
| Example 2 | Cu | 8 | 0.28 | 2.2 | 0.28 | Present |
| Example 3 | Ni | 10 | 0.68 | 4.5 | 0.45 | Present |
| Example 4 | Ag/Cu | 8 | 0.27 | 2.0 | 0.25 | Present |
| Example 5 | C/Cu | 8 | 0.29 | 2.1 | 0.26 | Present |
| Comparative | Ni/Cu | 35 | 2.81 | 11.0 | 0.31 | Present |
| Example | | | | | | |
| Comparative | Cu | 8 | 0.30 | 2.2 | 0.28 | Absent |
| Example 2 | | | | | | |

### [Evaluation]

Regarding the solid-state secondary batteries produced in Examples 1 to 5 and Comparative Examples 1 and 2, the composite elastic moduli of the solid electrolyte layers, the intermediate layers, and the negative electrode current collectors, the relative densities, arithmetic average roughness Ra and maximum height roughness Rz of the intermediate layers, and the initial internal resistance values of the batteries were measured by the following methods, and the cross-sectional observation of lithium metal layers at the time of SOC 50% and cycle tests were performed. The thicknesses T, arithmetic average roughness Ra, and maximum height roughness Rz of the negative electrode current collectors of the solid-state secondary batteries produced in Examples 1 to 5 and Comparative Examples 1 and 2 were the same as those before the production of the solid-state secondary batteries.

### (Measurement of Composite Elastic Moduli of Solid Electrolyte Layer, Intermediate Layer, and Negative Electrode Current Collector)

The solid-state secondary battery immediately after being assembled was disassembled, and the electrode laminate was taken out. The composite elastic moduli of the solid electrolyte layer, the intermediate layer, and the negative electrode current collector of the obtained electrode laminate were measured by a nanoindentation method.

### (Relative Density, Arithmetic Average Roughness Ra, and Maximum Height Roughness Rz of Intermediate Layer)

The solid-state secondary battery immediately after being assembled was disassembled, the electrode laminate was taken out, and the relative density, arithmetic average roughness Ra, and maximum height roughness Rz of the intermediate layer were measured.

The relative density was calculated by the following formula (1). In the formula (1), “packing density” can be calculated by the area density×thickness of the intermediate layer. The area density of the intermediate layer can be calculated from the area and weight of the intermediate layer before transfer. The thickness of the intermediate layer can be measured by performing the cross-sectional processing of the electrode laminate and then observing a cross section of the electrode laminate using SEM (scanning electron microscope). Relative density (%)=packing density (g/cc)/true density (g/cc)×100 . . . (1)

The method for calculating the relative density is not limited to the above-described method, and the relative density may be calculated by instrumental analysis by a BET method, a porosimeter, gas diffusion, or the like or image analysis with SEM or the like.

The arithmetic average roughness Ra and maximum height roughness Rz of the intermediate layer were measured with a laser microscope using the intermediate layer exposed by taking the negative electrode current collector from the electrode laminate.

### (Measurement of Initial DC Resistance Value)

Initial charging and discharging was performed by charging the solid-state secondary battery at a temperature of 25° C., a current value of 0.1 C, and a voltage value set to 4.3 V under a constant-current/constant voltage (CCCV) condition and then discharging the solid-state secondary battery to 2.65 V at a temperature of 60° C. and a current value of 0.1 C under a constant-current (CC) condition. Next, the solid-state secondary battery was aged, and SOC was then adjusted to 50% at a temperature of 60° C., a current value of 0.1 C, and a voltage value set to a voltage equivalent to SOC 50% under a constant-current/constant voltage (CCCV) condition. Initial internal resistance (Ω/cm²) was calculated by the following formula from a voltage drop ΔV (V), a current value I (A), and a positive electrode area Ac (cm²) at the time of discharging the solid-state secondary battery adjusted to SOC 50% at a temperature of 25° C. and a current density of 15.1 mA/cm². The results are shown in Table 2 below. Initial DC resistance (Ω/cm²)=voltage drop ΔV (V)/current value I (A)×positive electrode area Ac (cm²)

### (Cross-Sectional Observation of Lithium Metal Layer in SOC 50% State)

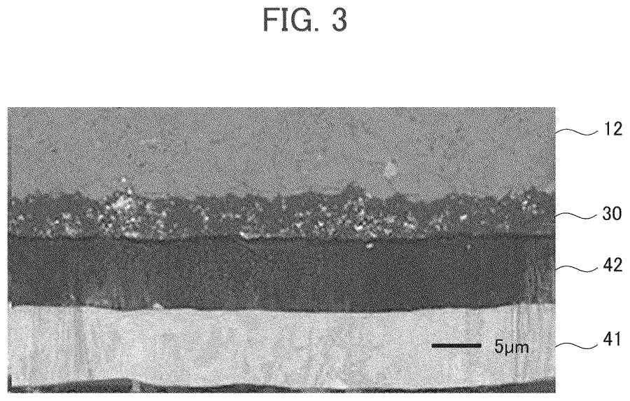

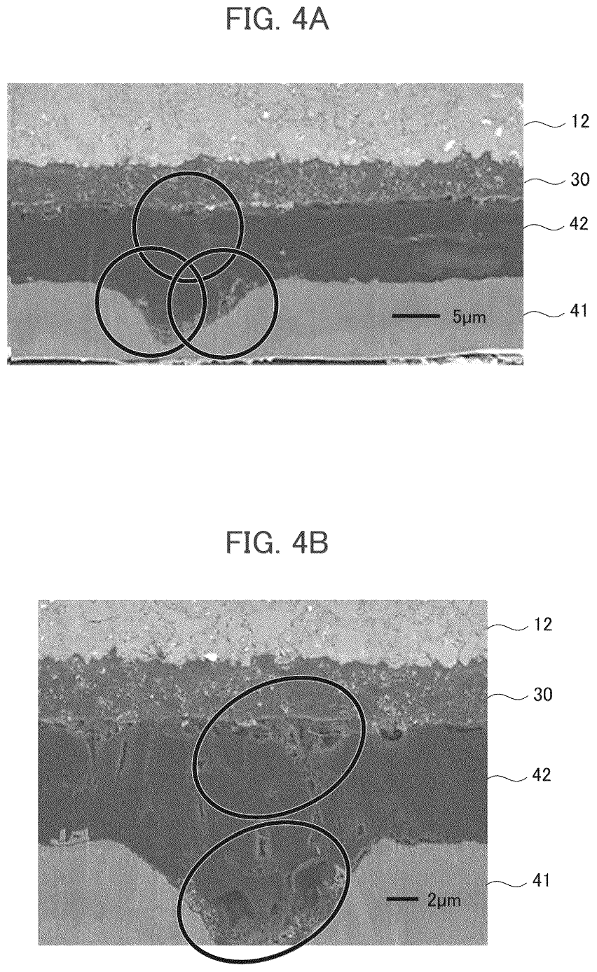

Initial charging and discharging was performed in the same manner as in the measurement of the initial DC resistance value, the solid-state secondary battery having SOC adjusted to 50% was disassembled, and the electrode laminate was taken out. A cross section of the lithium metal layer precipitated on a surface of the negative electrode current collector of the taken-out electrode laminate was observed using SEM (scanning electron microscope). The cross section of the lithium metal layer was observed at 10 places. When pores were not observable at all of the 10 places, the lithium metal layer was regarded as being “with no pores”, and when pores were observable even at one place out of the 10 places, the lithium metal layer was regarded as being “with pores”. The results are shown in Table 2 below. FIG. 3 is a cross-sectional SEM photograph of the electrode laminate of the solid-state secondary battery produced in Example 2, and FIG. 4A and FIG. 4B are cross-sectional SEM photographs of the electrode laminate of the solid-state secondary battery produced in Comparative Example 1.

### (Cycle Test)

A charge/discharge cycle test was performed by performing constant-current/constant voltage (CCCV) charging and constant-current (CC) discharging at a temperature of 45° C. and a current value of 1/3 C within a voltage range with an upper limit voltage of 4.3 V and a lower limit voltage of 2.65 V. Discharge capacity retention rates at the 50^{th} cycle are shown in Table 2.

TABLE 2

| | | | | | | | | | Discharge |
|---|---|---|---|---|---|---|---|---|---|
| | Composite elastic modulus(GPa) | | | Intermediate layer | | | | Cross- | capacity |
| | | | Negative | | Arithmetic | Maximum | Initial DC | sectional | retention |
| | | | electrode | | average | height | resistance | observation | rate 50 |
| | Solid | Intermediate | current | Relative | roughness | roughness | value | of lithium | cycles |
| | electrolyte | layer | collector | density(%) | Ra(μm) | Rz(μm) | (Ω · cm²) | metal layer | (%) |
| Example 1 | 25 | 0.8 | 204 | 45 | 0.13 | 0.88 | 18.12 | With no pores | 98.45 |
| Example 2 | 25 | 0.8 | 118 | 45 | 0.13 | 0.88 | 18.46 | With no pores | 98.28 |
| Example 3 | 25 | 0.8 | 204 | 45 | 0.13 | 0.88 | 19.51 | With no pores | 98.07 |
| Example 4 | 25 | 0.8 | 159 | 45 | 0.13 | 0.88 | 20.74 | With no pores | 98.51 |
| Example 5 | 25 | 0.8 | 1.6 | 45 | 0.13 | 0.88 | 21.86 | With no pores | 98.34 |
| Comparative | 25 | 0.8 | 178 | 45 | 0.13 | 0.88 | 36.15 | With pores | 92.67 |
| Example 1 | | | | | | | | | |
| Comparative | 25 | 0.8 | 118 | 45 | 0.13 | 0.88 | 85.38 | With pores | Evaluation |
| Example 2 | | | | | | | | | impossible * |

In the solid-state secondary batteries of Examples 1 to 5 in which the arithmetic average roughness Ra of the negative electrode current collectors was within the range of the present invention and the intermediate layers having a smaller composite elastic modulus than the negative electrode current collectors were present between the solid electrolyte layer and the negative electrode current collector, which are shown in the results in Table 2 and the cross-sectional SEM photograph of FIG. 3, it is found that the initial DC resistance values were low, no pores were observed in the lithium metal layers of the negative electrode layers, the discharge capacity retention rates at the 50^{th} cycle were high, and favorable cycle characteristics were exhibited. In contrast, in the solid-state secondary battery of Comparative Example 1 in which the arithmetic average roughness Ra of the negative electrode current collector exceeded the range of the present invention, the initial DC resistance value was high, pores were generated in the lithium metal layer 42, which was present between the negative electrode current collector 41 and the intermediate layer 30, as shown in black circles in FIG. 4A and FIG. 4B, and the discharge capacity retention rate at the 50^{th} cycle became low. In addition, in the solid-state secondary battery of Comparative Example 2 in which no intermediate layers were present between the solid electrolyte layer and the negative electrode current collector, the initial DC resistance value became significantly high, a short circuit behavior was exhibited in the middle of charging at a temperature of 45° C. and a current value of 1/3 C, and it was not possible to continue the cycle test.

### EXPLANATION OF REFERENCE NUMERALS

1 Solid-state secondary battery
10 Positive electrode layer
11 Positive electrode current collector
12 Positive electrode active material layer
20 Solid electrolyte layer
21 Solid electrolyte material
30 Intermediate layer
40 Negative electrode layer
41 Negative electrode current collector
42 Lithium metal layer

What is claimed is:

1. A solid-state secondary battery comprising:
an electrode laminate in which a positive electrode layer, a negative electrode layer, a solid electrolyte layer provided between the positive electrode layer and the negative electrode layer, and an intermediate layer provided between the negative electrode layer and the solid electrolyte layer are laminated,
wherein the negative electrode layer includes a negative electrode current collector,
the negative electrode current collector has an arithmetic average roughness Ra of smaller than 2.5 μm, and
the intermediate layer has a smaller composite elastic modulus than the negative electrode current collector.

2. The solid-state secondary battery according to claim 1, wherein the negative electrode current collector has a maximum height roughness Rz of smaller than 10 μm.

3. The solid-state secondary battery according to claim 1, wherein before charging, the negative electrode current collector is in contact with the intermediate layer.

4. The solid-state secondary battery according to claim 1, wherein the intermediate layer has an arithmetic average roughness Ra of smaller than 1 μm and a maximum height roughness Rz of smaller than 4 μm on a side opposite to the negative electrode current collector.

5. The solid-state secondary battery according to claim 1, wherein the intermediate layer has a composite elastic modulus of less than 1 GPa.

6. The solid-state secondary battery according to claim 1, wherein the intermediate layer has a relative density of 30% to 60%.

7. The solid-state secondary battery according to claim 1, wherein the intermediate layer contains amorphous carbon.

8. The solid-state secondary battery according to claim 1, wherein the intermediate layer has a smaller composite elastic modulus than the solid electrolyte layer.
